(19) United States
(12) Patent Application Publication
(10) Pub. No.: US 2006/0132831 A1
(43) Pub. Date: Jun. 22, 2006

(54) Image forming apparatus and method of controlling apparatus

(75) Inventors: Takao Iwasaki, Tokyo (JP); Naoto Okazaki, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,454

(22) Filed: Dec. 16, 2004

(51) Int. Cl. G06F 3/12

(52) U.S. Cl. 358/1.15

(57) ABSTRACT

In preparation for facsimile transmission, a destination list is displayed. The destination list shows destination-name columns, Fax buttons, and E-mail buttons.

### BACKGROUND OF THE INVENTION

1. Field of the Invention

The present invention relates to an image forming apparatus of multi-function peripheral type, and to a method of controlling the apparatus.

2. Description of the Related-Art

An image forming apparatus of multi-function peripheral (MFP) type, which performs not only the ordinary copying function, but also facsimile function, scanning function, network printing function and the like.

The facsimile function includes facsimile transmission in which images are transmitted to a telephone line, and facsimile transmission in which images are transmitted to a communications network (such as the Internet or a LAN).

In the facsimile transmission, wherein images are transmitted to a telephone line, it is necessary to input or designate a telephone number. In the facsimile transmission, wherein images are transmitted to a communications network, it is necessary to input or designate an E-mail address.

### BRIEF SUMMARY OF THE INVENTION

An object of this invention is to provide an image forming apparatus with which a destination of facsimile transmission can be easily and unmistakably designated, and a method of controlling the apparatus, too.

An image forming apparatus according to one aspect of the present invention comprises: a first control section which performs first facsimile transmission to transmit images to a telephone line and second facsimile transmission to transmit the images to a communications network; a display section; and a second control section which displays at least one destination-name column for designating a destination of the facsimile transmission, a Fax button for designating, as telephone number of a destination of the first facsimile transmission, a telephone number associated with a destination name described in the destination-name column, and an E-mail button for designating, as E-mail address of a destination of the second facsimile transmission, an E-mail address associated with the destination name described in the destination-name column.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a diagram showing the outer appearance of an embodiment;

FIG. 2 is a diagram depicting the configuration of the control panel of the embodiment;

FIG. 3 is a block diagram of the control circuit of the embodiment;

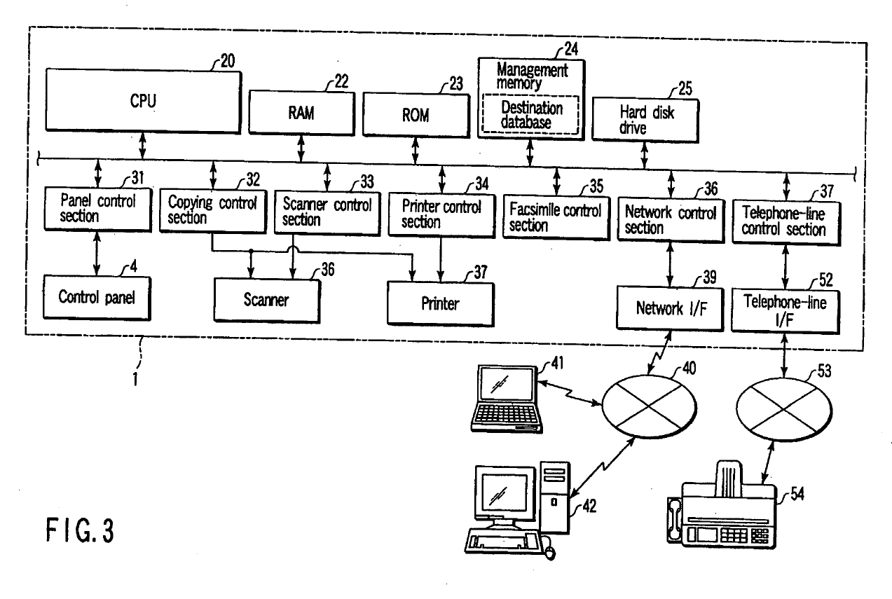

FIG. 4 is a flowchart for explaining the operation of the embodiment;

FIG. 5 is a diagram for explaining how to operate the Fax button on the destination list displayed in the embodiment;

FIG. 6 is a diagram illustrating how the destination list is changed by performing the operation shown in FIG. 5;

FIG. 7 is a diagram showing how the destination list is changed from the state shown in FIG. 6;

FIG. 8 is a diagram for explaining how to operate the E-mail button on the destination list displayed in the embodiment;

FIG. 9 is a diagram illustrating how the destination list is changed by performing the operation shown in FIG. 8;

FIG. 10 is a diagram depicting a destination list of another type displayed in the embodiment;

FIG. 11 is a diagram for explaining how to manipulate the destination list displayed in the embodiment; and

FIG. 12 is a diagram illustrating how the destination list is changed by performing the operation shown in FIG. 11.

### DETAILED DESCRIPTION OF THE INVENTION

An embodiment of the present invention will be described, with reference to the accompanying drawings.

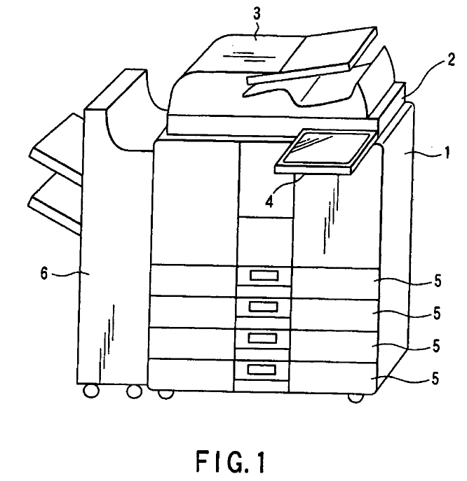

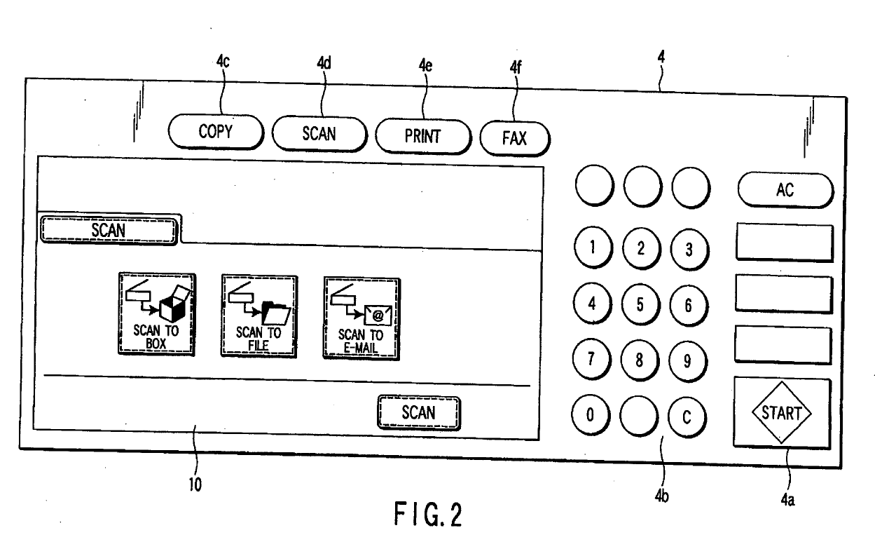

As FIG. 1 shows, an image forming apparatus has a main unit 1 and a document table 2 mounted on the top of the main unit 1. An automatic document feeder (ADF) 3 is provided on the document table 2 and can be opened and closed. At the same level as the document table 2, a control panel 4 is provided to function as operation means for setting operating conditions. As FIG. 2 shows, the control panel 4 has a start key 4a, a ten-key pad 4b (i.e., an operation section for inputting telephone numbers), a copy key 4c, a scan key 4d, a print key 4e, a facsimile key 4f, a set/register key 4g, a liquid crystal display screen (i.e., display section) 10, and the like.

A plurality of cassettes 5 are provided in the lower part of the main unit 1. Each cassette 5 contains paper sheets of a specific size, which are image-forming media. A sheet-tray unit 6 is provided on one side of the main housing. The unit 6 receives printed paper sheets from the main unit 1.

The main unit 1 incorporates a CPU 20 that is the main control unit. To the CPU 20 there are connected a RAM 22, a ROM 23, a management memory 24 (nonvolatile memory), a hard disk drive 25, a panel control section 31, a copying control section 32, a scanner control section 33, a printer control section 34, a facsimile (Fax) control section 35, a network control section 38, and a telephone-line control section 51.

The RAM 22 is provided to store various data items. The ROM 23 stores various control programs that are necessary to the main unit 1. The management memory 24 stores a destination database that is used in facsimile transmission. The hard disk drive 25 stores image data that represents the image scanned in the main unit 1.

The panel control section 31 controls the control panel 4. The copying control section 32 controls the ordinary copying function accomplished by using the scanner 36 and printer 37. The scanner control section 33 controls the scanning functions carried out by using the scanner 36. (The scanning functions include a scan-to-box function, scan-to-file function and scan-to-E-mail function.) The printer control section 34 controls the network print function achieved by using the printer 37.

The network control section 38 controls the data transfer with a communications network 40 via a network interface 39. External apparatuses, for example, personal computers 41 and 42, are connected to the communications network 40. The personal computers 41 and 42 have E-mail addresses specific to them, respectively. The E-mail addresses are registered in the above-mentioned destination database, along with the names (destination names) of the companies in which the personal computers are installed.

The telephone-line control section 51 controls the communication with the public telephone line 53, via a telephone-line interface 52. The public telephone line 53 can connect the main unit 1 to a facsimile apparatus 54. A specific telephone number is assigned to the facsimile apparatus 54. This telephone number is registered in the above-mentioned destination database, along with the name of, for example, the company in which the facsimile apparatus 54 is installed.

The facsimile control section 35 uses the network control section 38 and telephone-line control section 51, controlling facsimile transmission. It has the following control sections (1) to (7), each performing a main function.

(1) The first control section that performs the first facsimile transmission (hereinafter called “Fax transmission”), i.e., transmitting image data to the public telephone line 53, and the second Fax transmission (hereinafter called “E-mail transmission”), i.e., transmitting image data to the communications network 40, when the facsimile key 4f is turned on to set the facsimile mode. The image data transmitted is one that represents the images scanned by the scanner 36 or one that is stored in the hard disk drive 25.

(2) The second control section that displays a. Fax button and an E-mail button in the liquid crystal display screen 10 when the facsimile mode is set. The Fax button may be depressed to select at least one destination-name column that is used to designate a destination name and the telephone number already associated with the destination name. The E-mail button may be depressed to select the E-mail address already associated with the destination name, so that an E-mail may be transmitted to the E-mail address selected.

(3) The third control section that has three means. The first means changes the color of the Fax button and the color of the destination-name column displayed near the Fax button, when the Fax button is touched and selected. The second means changes the color of the E-mail button and the color of the destination-name column displayed near the E-mail button, when the E-mail button is touched and selected. The third means changes the color of the destination-name column and the colors of the Fax button and E-mail button, which are displayed near the destination-name column, when the destination-name column is touched and selected.

(4) The fourth control section that has four means. The first means designates a telephone number as the destination of Fax transmission when the Fax button is touched and specifies the telephone number. The second means designates a telephone number as the destination of Fax transmission when the ten-key pad 4b is operated, inputting the telephone number. The third means designates an E-mail address as the destination of E-mail transmission when the E-mail button is touched, specifying the E-mail address. The fourth means designates a telephone number and an E-mail address as the designation of Fax transmission and the destination of E-mail transmission, respectively, when the destination-name column is touched, specifying the telephone number and the E-mail address.

(5) The fifth control section that counts one or more destinations designated by the fourth control section and displays the count value, as destination number, in the liquid crystal display screen 10.

(6) The sixth control section that displays, in the liquid crystal display screen 10, a destination-confirmation screen showing one or more destinations designated by the fourth control section, each arranged for the associated destination name.

(7) The seventh control section that deletes at least one of the destinations, which has been designated in the destination-confirmation screen displayed by the sixth control section.

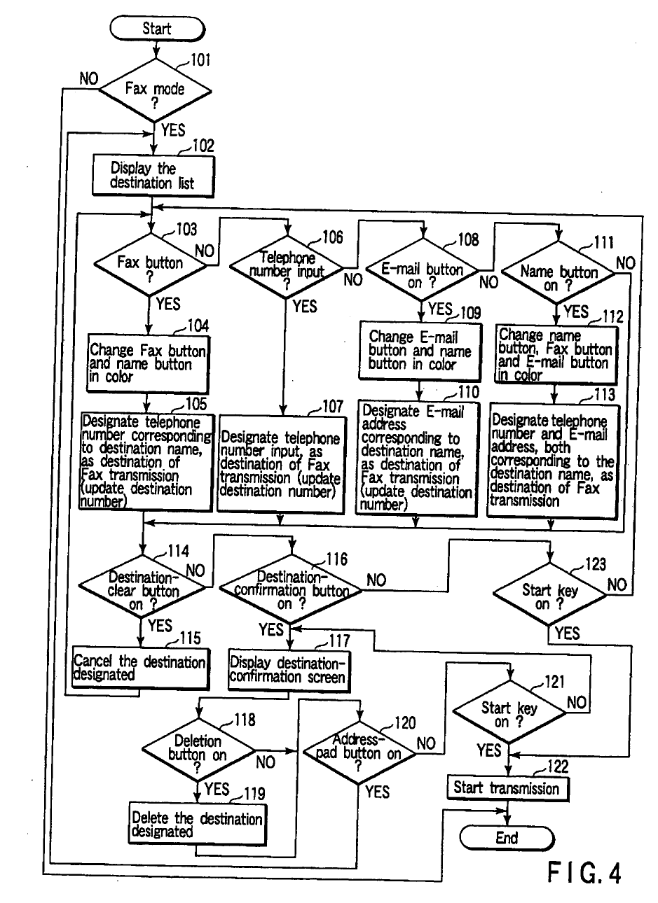

The operation will be described, with reference to the flowchart of FIG. 4.

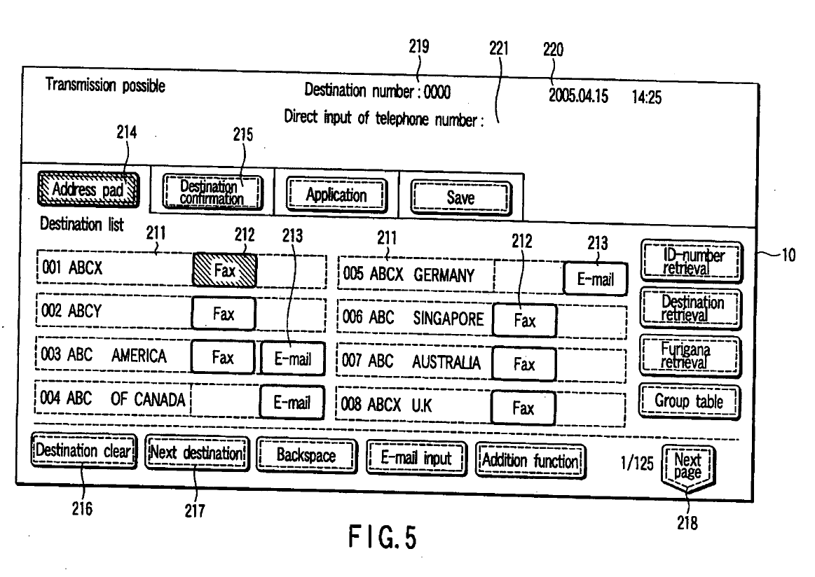

When the facsimile key 4f of the control panel 4 is turned on, the facsimile mode is set. When the facsimile mode is thus set (YES in Step 101), the liquid crystal display screen 10 of the control panel 10 displays a destination list shown in FIG. 5.

In the destination list, a plurality of destination-name columns 211 are arranged, each arranged to designate a destination of Fax transmission. In each destination-name column 211, a serial number and a destination name are described. A Fax button 212 and an E-mail button 213 are displayed near each destination-name column 211. The Fax button 212 may be touched to designate, as telephone number of a destination of Fax transmission, the telephone number associated with the destination name described in the destination-name column 211. The E-mail button 213 may be touched to designate, as E-mail address of a destination of E-mail transmission, the E-mail address associated with the destination name described in the destination-name column 211.

Only a Fax button 212 is shown in the upper-left destination-name column 211 having serial number “001”. Both a Fax button 212 and an E-mail button 213 are shown in the destination-name column 211 having serial number “003”. Only an E-mail button 213 is shown in the destination-name column 211 having serial number “004”.

An address-pad button 214 and a destination-confirmation button 215 are displayed in the vicinity of the upper-left destination-name column 211 having serial number “001”. A destination-clear button 216 and a next-destination button 217 are displayed in the vicinity of the lower-left destination-name column 211 having serial number “004”. A next-page button 218 is displayed in the vicinity of the lower-right destination-name column 211 having serial number “008”.

When touched with a finger, the destination-name columns 211, Fax buttons 212, E-mail button 213, address-pad button 214, destination-confirmation button 215, destination-clear button 216, next-destination button 217 and next-page button 218 can be touched with a finger can be turned on.

The destination list consists of 1 to 125 pages. Every time the next-page button 218 is turned on, the next page of the destination list is displayed, in place of the preceding page.

The liquid crystal display screen 10 has, in its top part, a destination-number display region 219, a data-time display region 220, and an input-telephone-number display region 221.

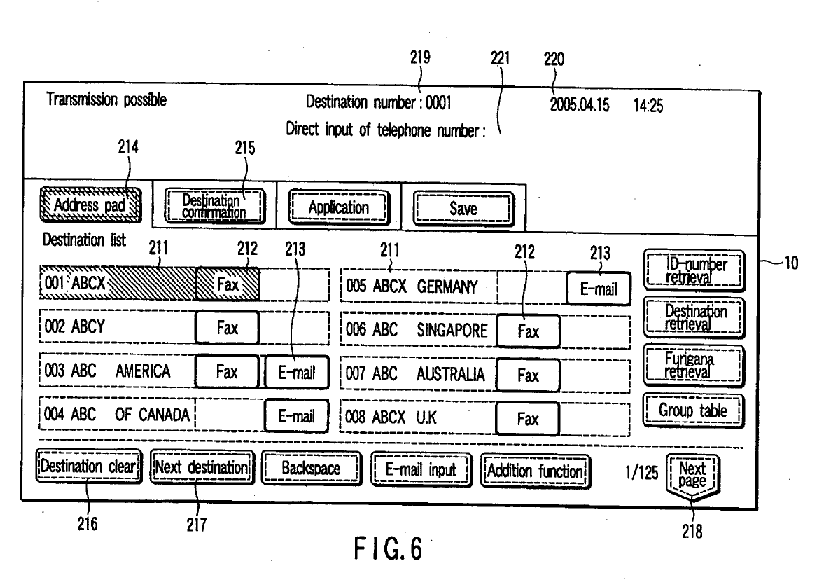

When the Fax button 212 displayed nears the destination-name column (destination name=ABCD) 211 having serial number “001” is turned on (YES in Step 103), the color of the Fax button 212 turned on changes, as indicated by shading in FIG. 5. Simultaneously, the color of the destination-name column 211 displayed near the Fax button 212 turned on, as indicated by shading in FIG. 6 (Step 104).

The destination-name column 211 or the Fax button 212, or both, the colors of which have changed in the destination list shown in FIG. 6, may be touched. In this case, the colors of both the destination-name column 211 and the Fax button 212 change back to the initial ones.

Assume that the next-destination button 217 may be turned on while the destination-name column 211 and Fax button 212 remain in changed color. Then, the telephone number associated with the destination name (ABCD) described in the column 211 displayed in changed color is read from the destination database that is stored in the management memory 24. The telephone number thus read is designated as destination of Fax transmission (Step 105). When the destination is so designated, it is counted. The count value obtained is displayed in the destination-number display region 219 provided in the top part of the liquid crystal display screen 10. (The destination number is updated.) That is, the destination number “0001” is displayed as is illustrated in FIG. 6.

If the destination-clear button 216 is turned on (YES in Step 114), the telephone number once designated as destination is cancelled (Step 115).

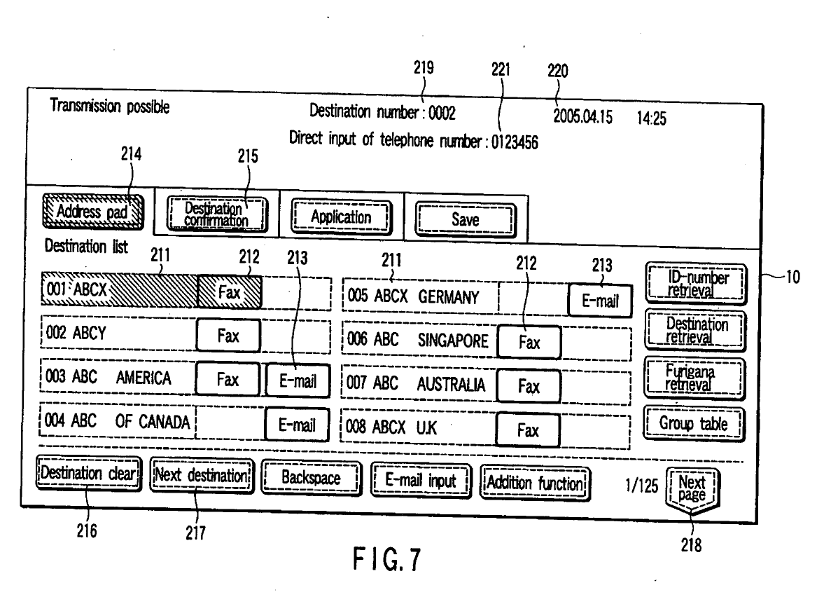

The ten-key pad 4b may be operated, inputting telephone number of, for example, “0123456” (YES in Step 106), the telephone number, i.e., “0123456”, is displayed in the input-telephone-number display region 221 provided in the top part of the liquid crystal display screen 10, as is illustrated in FIG. 7. The next-destination button 217 may be turned on in this state. Then, the telephone number input is designated as destination of Fax transmission (Step 107). When the destination is thus designated, it is counted. The count value obtained is displayed as destination number in the destination-number display region 219 provided in the top part of the liquid crystal display screen 10. (The destination number is updated.) That is, the destination number “0002” is displayed as is illustrated in FIG. 6.

If the destination-clear button 216 is turned on (YES in Step 114), the telephone number once designated as destination is cancelled (Step 115).

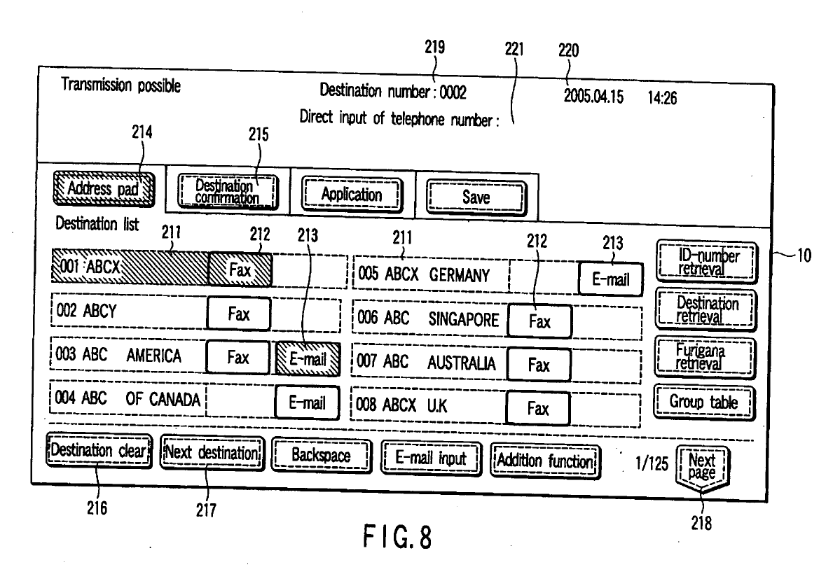

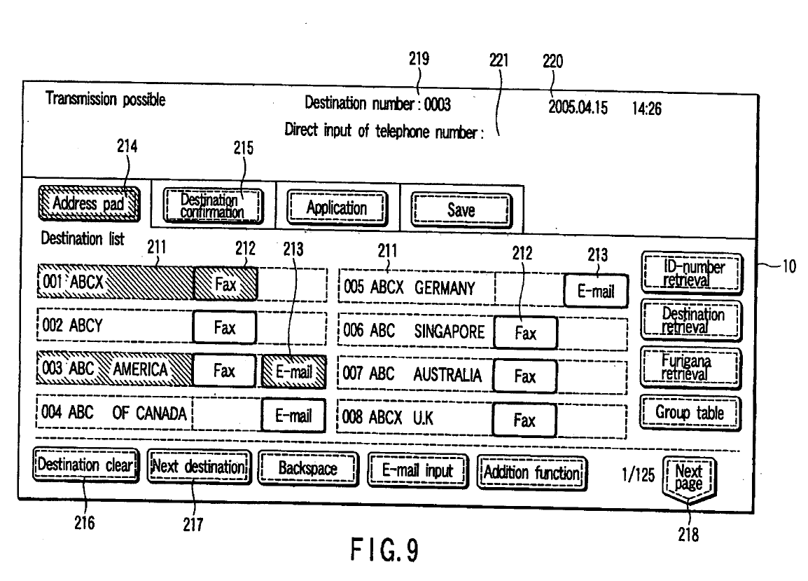

Next, the E-mail button 213 displayed near the destination-name column 211 (destination name=ABC AMERICA) having serial number “003” may be turned on (YES in Step 108). In this case, the E-mail button 213 changes in color as indicated by shading in FIG. 8. Simultaneously, the destination-name column 211 displayed near the E-mail button 213 that has been turned on changes in color as indicated by shading in FIG. 9 (Step 109). The next-destination button 217 may be turned on in this state. Then, the E-mail address associated with the destination name (ABC AMERICA) described in the destination-name column 211 changed in color is read from the destination database that is stored in the management memory 24. The E-mail address thus read is designated as destination of E-mail transmission (Step 110). When the destination is so designated, it is counted. The count value obtained is displayed in the destination-number display region 219 provided in the top part of the liquid crystal display screen 10. (The destination number is updated.) Thus, the destination number “0003” is displayed as is depicted in FIG. 9. Seeing this number “0003”, the operator can know that three destinations have been designated.

If the destination-clear button 216 is turned on (YES in Step 114), the telephone number once designated as destination is cancelled (Step 115).

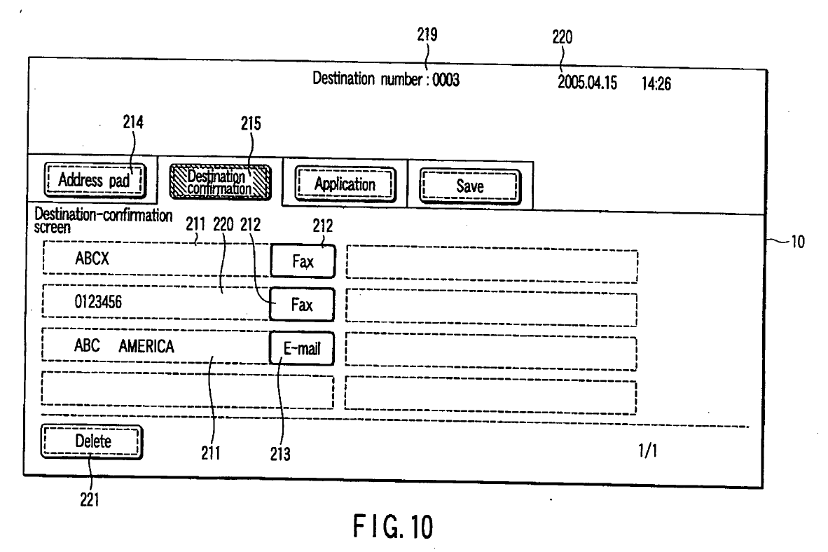

Assume that the destination-confirmation button 215 is turned on (YES in Step 116) after three destinations have been designated as shown in FIG. 9. Then, the destination list displayed is switched to a destination-confirmation screen as shown in FIG. 10 (Step 117).

In the destination-confirmation screen, the destination-name column 211 (destination name=ABCX) and Fax button 212 are displayed at the uppermost stage, the telephone-number column 220 in which “0123456” is described and E-mail button 213 are displayed at the second stage, and the destination-name column 211 (destination name=ABC AMERICA) and E-mail button 213 are displayed at the third stage. The destination number “0003” is displayed in the destination-number display region 219 provided in the top part of the liquid crystal display screen 10.

The destination-name column 211 (destination name=ABCX) and the Fax button 212, which are displayed at the uppermost stage, indicate a Fax transmission to the first destination, i.e., “ABCX”. The telephone-number column 220 and the E-mail button 213, which are displayed at the second stage, indicate a Fax transmission to the second destination, i.e., the telephone number “0123456”. The destination-name column 211 (destination name=ABC AMERICA) and the E-mail button 213, which are displayed at the third stage, indicate an E-mail transmission to the third destination, i.e., “ABC AMERICA”.

Reading the data displayed in the destination-confirmation screen, the operator can correctly grasp the three destinations that have been designated.

The destination-name column 211 (destination name=ABCX) displayed at the uppermost stage, and the deletion button 221, both displayed in the destination-confirmation screen, may be turned on (YES in Step 118). In this case, the first destination (i.e., Fax transmission to “ABCX”) is deleted (Step 119). At the same time, the uppermost destination column 211 (destination name=ABCX) and the Fax button 212 are deleted.

While the destination-confirmation screen is being displayed, the start key 4a of the control panel 4 may be turned on (YES in Step 121). In this case, the Fax transmission and E-mail transmission of images to all destinations displayed in the destination-confirmation screen are started (Step 122).

When the address-pad button 214 displayed in the destination-confirmation screen is turned on (YES in Step 120), the display is switched from the destination-confirmation screen back to the destination list shown in FIG. 9 (Step 102).

Assume that the start key 4a of the control panel 4, displayed in the destination list is turned on (YES in Step 123). Then Fax transmission and E-mail transmission of images to all destinations thus far designated are started (Step 122).

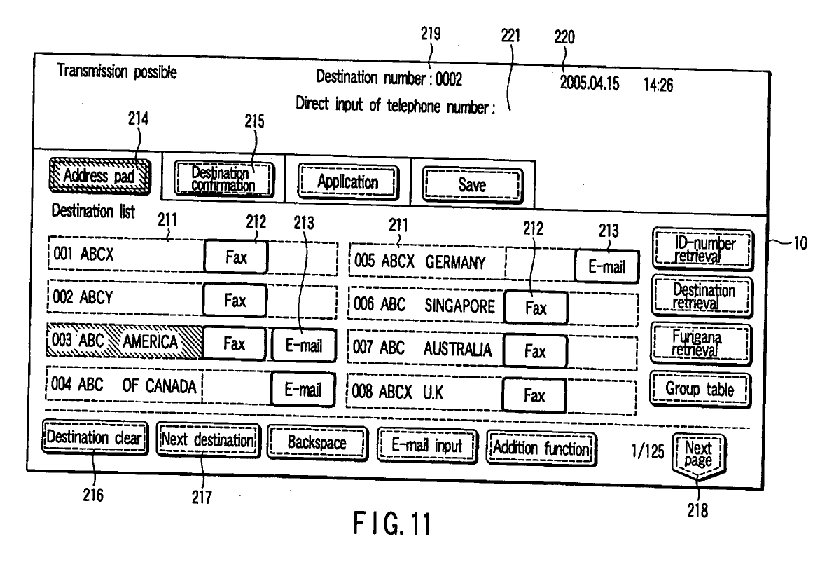

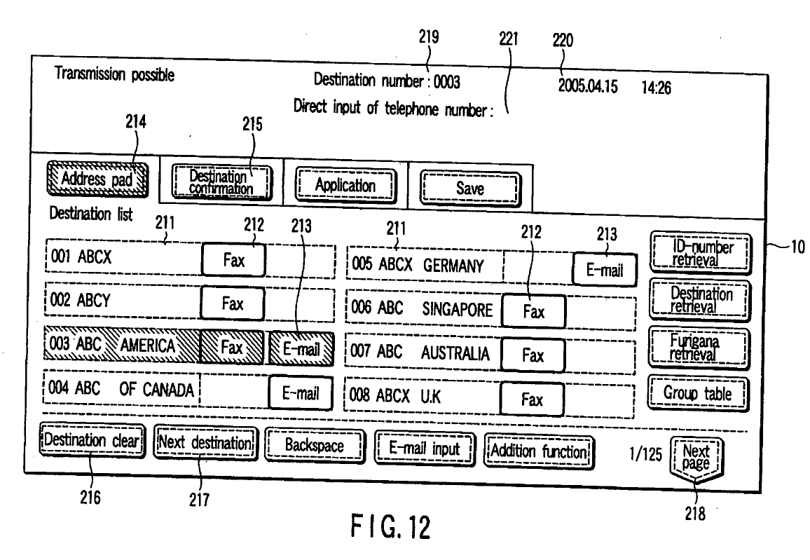

For example, the destination-name column 211 (destination name=ABC AMERICA) having serial number “003” displayed in the destination list may be turned on (YES in Step 111). If this is the case, the destination-name column 211 turned on changes in color as indicated by shading in FIG. 11. Simultaneously, the Fax button 212 and the M-mail button 213, both displayed near the destination-name column 211 turned on, change in color as indicated by shading in FIG. 12 (Step 112). If the next-destination button 217 may be turned on in this state, the telephone number and the E-mail address, both associated with the destination-name column 211 (destination name=ABC AMERICA), are read from the destination database that is stored in the management memory 24. The telephone number and the E-mail address, thus read, are designated as the destination of Fax transmission and the destination of E-mail transmission, respectively (Step 113).

As has been described, a destination list having a destination-name column 211, Fax button 212 and E-mail button 213 is displayed when a facsimile transmission is to be carried out. This enables the operator to designate destinations of the facsimile transmission, easily and unmistakably.

Since the serial number of the last destination designated is displayed, the operator can easily know now many destinations have been designated.

Since a destination-confirmation screen is displayed, the operator can correctly grasp all destinations designated in detail.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising:
a first control section which performs first facsimile transmission to transmit images to a telephone line and second facsimile transmission to transmit the images to a communications network;
a display section; and
a second control section which displays at least one destination-name column for designating a destination of the facsimile transmission, a Fax button for designating, as telephone number of a destination of the first facsimile transmission, a telephone number associated with a destination name described in the destination-name column, and an E-mail button for designating, as E-mail address of a destination of the second facsimile transmission, an E-mail address associated with the destination name described in the destination-name column.

2. The apparatus according to claim 1, further comprising a third control section which has means for changing, in color, the Fax button and the destination-name column displayed near the Fax button, when the Fax button is selected, and means for changing, in color, the E-mail button and the destination-name column displayed near the E-mail button, when the E-mail button is selected, and means for changing, in color, the destination-name column and the Fax button and the E-mail button, both displayed near the destination-name column, when the destination-name column is selected.

3. The apparatus according to claim 1, further comprising a fourth control section which designates a telephone number as destination of the first facsimile transmission when the Fax button for designating the telephone number is selected, which designates an E-mail address as destination of the second facsimile transmission when the E-mail button for designating the E-mail address is selected, and which designates a telephone number and an E-mail address as destinations of the first and second facsimile transmissions, respectively, when the Fax button and E-mail button for designating the telephone number and E-mail address, respectively, are selected.

4. The apparatus according to claim 3, further comprising a fifth control section which counts one or more destinations in units of destination names designated by the fourth control section, thereby obtaining a count value, and which causes the display section to display the count value.

5. The apparatus according to claim 3, further comprising a sixth control section which causes the display section to display a destination-confirmation screen that shows one or more destinations designated by the fourth control section and arranged for the destination names, respectively.

6. The apparatus according to claim 5, further comprising an operation section which instructs the sixth control section to perform the displaying of the destination-confirmation screen.

7. The apparatus according to claim 6, wherein the operation section is a destination-confirmation button and displayed by the display section.

8. The apparatus according to claim 5, further comprising a seventh control section which deletes any designated one of the destinations displayed in the destination-confirmation screen under the control of the sixth control section.

9. The apparatus according to claim 8, further comprising an operation section which causes the seventh control section to delete any designated destination.

10. The apparatus according to claim 9, wherein the operation section is a deletion button and displayed in the destination-confirmation screen.

11. The apparatus according to claim 1, further comprising an operation section which inputs telephone numbers.

12. The apparatus according to claim 1, further comprising a fourth control means which has means for designating a telephone number as destination of the first facsimile transmission when the Fax button for designating the telephone number is selected, means for designating a telephone number as destination of the first facsimile transmission when the telephone number is input at the operation section, means for designating an E-mail address as destination of the second facsimile transmission when the E-mail button for designating the E-mail address is selected, and means for designating a telephone number and an E-mail address as destinations of the first and second facsimile transmissions, respectively, when the Fax button and E-mail button for designating the telephone number and E-mail address, respectively, are selected.

13. The apparatus according to claim 12, further comprising a fifth control section which counts one or more destinations in units of destination names designated by the fourth control section, thereby obtaining a count value, and which causes the display section to display the count value.

14. The apparatus according to claim 12, further comprising a sixth control section which causes the display section to display a destination-confirmation screen that shows one or more destinations designated by the fourth control section and arranged for the destination names, respectively.

15. The apparatus according to claim 14, further comprising an operation section which instructs the sixth control section to perform the displaying of the destination-confirmation screen.

16. The apparatus according to claim 15, wherein the operation section is a destination-confirmation button and displayed by the display section.

17. The apparatus according to claim 14, further comprising a seventh control section which deletes any designated one of the destinations displayed in the destination-confirmation screen displayed under the control of the sixth control section.

18. The apparatus according to claim 17, further comprising an operation section which causes the seventh control section to delete any designated destination.

19. The apparatus according to claim 18, wherein the operation section is a deletion button and displayed in the destination-confirmation screen.

20. A method of controlling an image forming apparatus comprising a control section which performs first facsimile transmission to transmit images to a telephone line and second facsimile transmission to transmit the images to a communications network, and a display section, said method comprising:
displaying, in the display section, at least one destination-name column for designating a destination of the facsimile transmission, a Fax button for designating, as telephone number of a destination of the first facsimile transmission, a telephone number associated with a destination name described in the destination-name column, and an E-mail button for designating, as E-mail address of a destination of the second facsimile transmission, an E-mail address associated with the destination name described in the destination-name column.
